(19) United States
(12) Patent Application Publication
(10) Pub. No.: US 2024/0011787 A1
(43) Pub. Date: Jan. 11, 2024

(54) OUTING PLAN GENERATION APPARATUS, METHOD, AND COMPUTER READABLE MEDIUM

(71) Applicant: NEC Corporation, Minato-ku, Tokyo (JP)

(72) Inventor: Nanami Kubota, Tokyo (JP)

(73) Assignee: NEC Corporation, Minato-ku, Tokyo (JP)

(21) Appl. No.: 18/037,955

(22) PCT Filed: Nov. 25, 2020
(86) PCT No.: PCT/JP2020/043783

§ 371 Date: May 19, 2023

(51) Int. Cl. G01C 21/36; G01C 21/34

(52) U.S. Cl. CPC G01C 21/3617; G01C 21/3492; G01C 21/3438; G01C 21/3423; G01C 21/362; G01C 21/3691

(57) ABSTRACT

Allows a user to use a public facility or the like avoiding a congested time. An outing trend acquisition means acquires an outing trend including a trend of a departure place, a destination, and a time zone in an outing of a user. A congestion trend acquisition means acquires a congestion trend at a destination of a user. An outing plan generation means generates an outing plan using a carpool vehicle as transportation on the basis of the outing trend acquired by the outing trend acquisition means and the congestion trend acquired by the congestion trend acquisition means.

### TECHNICAL FIELD

The present disclosure relates to an outing plan generation apparatus, a method, and a computer readable medium.

### BACKGROUND ART

In the near future, more elderly people will return their driver's licenses from the viewpoint of accident prevention, and this will increase the number of elderly people without driver's licenses. However, in some areas where public transportation is not well developed, daily life can be difficult without a private car or other transportation. At present, many elderly people are at risk of traffic accidents but still desperately need to travel by private car. Services that provide relatively freely available vehicles are desired.

As a related art, Patent Literature 1 discloses an apparatus for assisting the travel of people and objects in daily life. In Patent Literature 1, a user who can assist another user transmits information to the server apparatus regarding the schedule for the travel of a person or object, such as a starting point, a destination, a departure time, and the number of people who can ride in the vehicle. On the other hand, a user who wish to receive assistance from another user transmits a request regarding the travel of a person or object to the server apparatus. Each user sets various conditions such as a moving schedule and desired date and time, and checks registration information of moving schedules or requests of other users. In a case where the user can be entrusted with a request for a travel registered by another user, the user transmits the request to the server.

As another related art, Patent Literature 2 discloses a ridesharing agreement registration agreement apparatus that manages ridesharing of a transportation system. The ridesharing registration agreement apparatus described in Patent Literature 2 receives reservation designation information from a mobile terminal of a ridesharing applicant. The reservation designation information includes information on a departure point and an arrival point. The shared-ride agreement registration apparatus creates ridesharing registration data on the basis of the accepted reservation designation information. The shared-ride agreement registration apparatus creates ridesharing route information on the basis of the ridesharing registration data.

### CITATION LIST

### Patent Literature

Patent Literature 1: Japanese Unexamined Patent Application Publication No. 2017-40961
Patent Literature 2: Japanese Unexamined Patent Application Publication No. 2009-122856

### SUMMARY OF INVENTION

### Technical Problem

The related art including Patent Literatures 1 and 2 allow ridesharing, in which a plurality of users share a single vehicle from their respective departure points to their respective destinations. The users can use ridesharing to go to public facilities. For example, the users can use ridesharing to go to stores or event venues near their arrival point. Alternatively, the users can use ridesharing to transfer to public transportation such a trains or buses at the arrival point and continue moving.

However, in the related art, congestion at the arrival point is not considered when using ridesharing. Therefore, the user may go to the store at times when the store is congested. Alternatively, the user may transfer to a congested train or the like at the arrival point and continue traveling.

In view of the above circumstances, an object of the present disclosure is to provide an outing plan generation apparatus, a method, and a computer readable medium that allows generation of an outing plan that enables a user to use a public facility or the like avoiding a congested time.

### Solution to Problem

In order to achieve the above object, the present disclosure provides, as a first aspect, an outing plan generation apparatus. An outing plan generation apparatus includes: an outing trend acquisition means for acquiring an outing trend including a trend of departure place, destination, and time zone in an outing of a user; a congestion trend acquisition means for acquiring a congestion trend at the destination of the user; and an outing plan generation means for generating an outing plan that uses the carpool vehicle as transportation on the basis of the outing trend of the user and the congestion trend.

The present disclosure provides an outing plan generation method as a second aspect. The outing plan generation method includes: acquiring an outing trend including a trend of departure place, destination, and time zone in an outing of a user; acquiring a congestion trend at the destination of the user; and generating an outing plan that uses the carpool vehicle as transportation on the basis of the outing trend of the user and the congestion trend.

The present disclosure provides a computer readable medium as a third aspect. The computer readable medium stores a program to cause a computer to execute: acquiring an outing trend including a trend of departure place, destination, and time zone in an outing of a user; acquiring a congestion trend at the destination of the user; and generating an outing plan that uses the carpool vehicle as transportation on the basis of the outing trend of the user and the congestion trend.

### Advantageous Effects of Invention

The outing plan generation apparatus, method, and computer readable medium according to the present disclosure allows generation of an outing plan that enables a user to use a public facility or the like avoiding a congested time.

### BRIEF DESCRIPTION OF DRAWINGS

FIG. 1 is a schematic block diagram illustrating an outing plan generation apparatus according to the present disclosure.

FIG. 2 is a block diagram illustrating an outing plan generation apparatus according to an example embodiment of the present disclosure.

FIG. 3 is a diagram schematically illustrating reservation of a carpool vehicle.

FIG. 4 is a flowchart illustrating an operation procedure in the outing plan generation apparatus.

FIG. 5 is a block diagram illustrating an example of a configuration of a computer apparatus.

### EXAMPLE EMBODIMENT

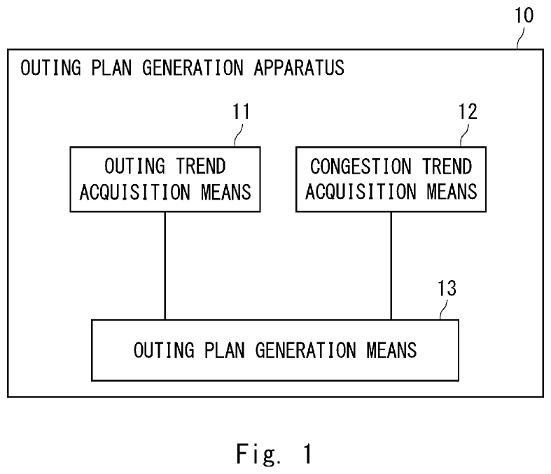

Prior to describing an example embodiment according to the present disclosure, an outline of the present disclosure will be described. FIG. 1 schematically illustrates an outing plan generation apparatus according to the present disclosure. The outing plan generation apparatus 10 includes an outing trend acquisition means 11, a congestion trend acquisition means 12, and an outing plan generation means 13. The outing plan generation apparatus 10 generates a plan (outing plan) for an outing using a carpool vehicle for a user who uses the carpool vehicle as transportation.

The outing trend acquisition means 11 acquires an outing trend including a trend of departure place, destination, and time zone in an outing of a user. The congestion trend acquisition means 12 acquires a congestion trend at the destination of the user. The outing plan generation means 13 generates an outing plan using a carpool vehicle as transportation on the basis of the outing trend of the user and the congestion trend of the destination.

In the present disclosure, the congestion trend acquisition means 12 acquires a congestion trend at a destination. The outing plan generation means 13 generates an outing plan using the acquired congestion trend. In the present disclosure, since the congestion trend is used to generate the outing plan, the outing plan generation means 13 can generate an outing plan that allows the user to arrive at the destination at a time when the destination is not congested. The user can avoid going out at times when the destination is congested by referring to the outing plan generated by the outing plan generation apparatus 10 and going out according to the outing plan.

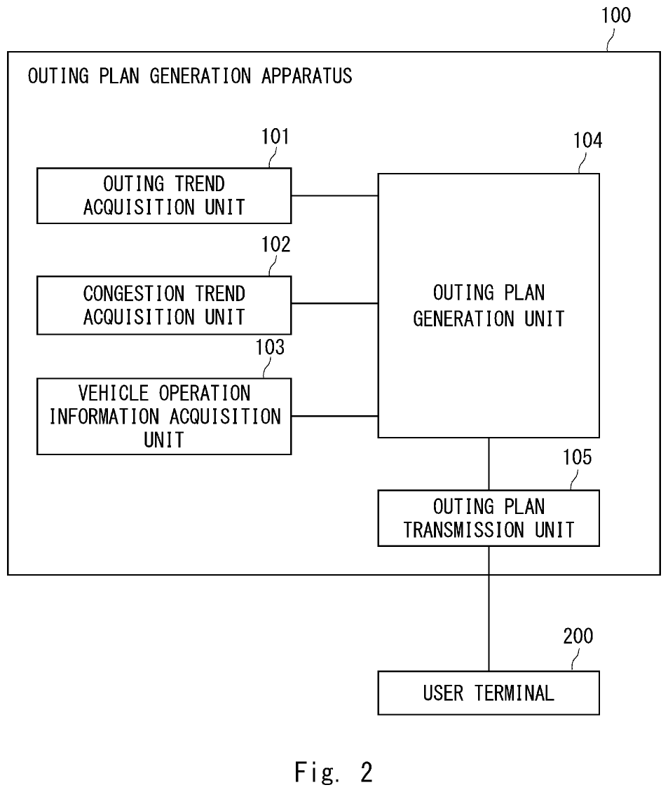

An example embodiment according to the present disclosure will be described hereinafter in detail. FIG. 2 illustrates an outing plan generation apparatus according to an example embodiment of the present disclosure. The outing plan generation apparatus 100 includes an outing trend acquisition unit 101, a congestion trend acquisition unit 102, a vehicle operation information acquisition unit 103, an outing plan generation unit 104, and an outing plan transmission unit 105. The outing plan generation apparatus 100 corresponds to the outing plan generation apparatus 10 illustrated in FIG. 1. The outing plan generation apparatus 10 proposes a plan (outing plan) for an outing using a carpool vehicle to a user who uses the carpool vehicle as transportation.

In the present example embodiment, the usage pattern of a carpool vehicle includes the usage pattern in which users use the carpool vehicle to travel between their homes and public facilities. Public facilities include railway stations, bus stops, commercial facilities, community centers, libraries, hospitals, and pharmacies. In this usage pattern, the fee for the use of the carpool vehicle is assumed to be a fixed amount in a case where the home and the public facility are located in the same district. In a case where the home and the utility are not located in the same district, the fee is added every time the public facility is away from the home by one section. The usage pattern for the carpool vehicle can include the usage pattern in which users use the carpool vehicle to travel between their homes and specific destinations, such as the homes of acquaintances. In the usage pattern, the fee for the use of the carpool vehicle is the basic fee plus an additional fee added according to the distance. The usage pattern of a carpool vehicle s is not specifically limited to the usage pattern described above. The usage pattern of a carpool vehicle may include the usage pattern in which a carpool vehicle is used for travel between any departure place and destination specified by the user.

The following discusses the usage patterns of a carpool vehicle in which users mainly use the carpool vehicle to travel between their homes and a public facility. In the present example embodiment, the carpool vehicle includes, for example, shared-ride taxis in which a plurality of customers share a single vehicle. The carpool vehicle also includes rideshare vehicles in which a driver rides with one or more users to transport them to their destination. It is assumed that reservation is necessary to use a carpool vehicle.

The outing trend acquisition unit 101 acquires the outing trend of the user of each user. The outing trend acquisition unit 101 acquires, for example, information indicating the trend of the departure place, destination, and time zone in outings using the carpool vehicle as an outing trend. The departure place indicates, for example, a point where the user gets on the carpool vehicle. The destination indicates, for example, a point where the user gets off the carpool vehicle. The destination may be a facility to be visited by the user after the user gets off the carpool vehicle. Alternatively, the destination may be a station, bus stop, or other point where the user transfer from a carpool vehicle to public transportation.

The outing trend acquisition unit 101 acquires the outing trend according to, for example, the characteristic of the user. The outing trend acquisition unit 101 may acquire, for example, information regarding the age, gender, and residential area of the user as the user characteristics, and acquire the outing trend on the basis of the acquired user characteristics. Alternatively or in addition, the outing trend acquisition unit 101 may acquire the past usage record of the carpool vehicle of the user as the user characteristic, and the outing trend acquisition unit 101 may acquire the outing trend on the basis of the acquired usage record. The outing trend acquisition unit 101 may acquire the past usage record from, for example, a service provider that offers a carpool vehicle service. Alternatively, the past usage record may be stored in the outing plan generation apparatus 100. The outing trend acquisition unit 101 corresponds to the outing trend acquisition means 11 illustrated in FIG. 1.

The congestion trend acquisition unit 102 acquires a congestion trend at the destination of the user who uses the carpool vehicle. The congestion trend acquisition unit 102 uses, for example, an index indicating the degree of congestion as a congestion index, and the congestion index at each time (time zone) at the destination as a congestion trend. For example, the congestion trend acquisition unit 102 may acquire a congestion trend of a facility such as a supermarket, a department store, or an event venue to which the user visits after getting off the carpool vehicle at the destination. When the user transfers to another transportation, the congestion trend acquisition unit 102 may acquire the congestion trend of the transportation after the transfer. The congestion trend acquisition unit 102 acquires, for example, information on train or bus operations, arrival-departure time at each station or bus stop, and a congestion index for each train or bus. The congestion trend acquisition unit 102 corresponds to the congestion trend acquisition means 12 illustrated in FIG. 1.

The vehicle operation information acquisition unit (operation information acquisition means) 103 acquires operation information of a carpool vehicle. The operation information includes a travel route and an operation time of the carpool vehicle. The vehicle operation information acquisition unit 103 acquires, for example, past operation results of a shared-ride taxi and a ride-sharing car as operation information.

The outing plan generation unit 104 generates an outing plan using a carpool vehicle as transportation on the basis of the outing trend of the user acquired by the outing trend acquisition unit 101, the congestion trend acquired by the congestion trend acquisition unit 102, and the operation information acquired by the vehicle operation information acquisition unit 103. In generating an outing plan, the outing plan generation unit 104 matches, for example, the outing trend of the user with the operation information on the carpool vehicle, and specifies the carpool vehicle that the user can use during the outing. The outing plan generation unit 104 may generate an outing plan for each user so that the outing time is distributed among a plurality of users. The outing plan generation unit 104 can generate an outing plan in a predetermined unit such as a week or a day, for example.

In generating an outing plan, the outing plan generation unit 104 may generate an outing plan so that, for example, the outing place (destination) and the date and time overlap among users whose homes are close to each other, while taking the life cycle of each individual into consideration. In that case, a carpool vehicle can be efficiently dispatched. When the user transfers to public transportation, the outing plan generation unit 104 may generate an outing plan according to the departure time of the public transportation to be transferred at the transfer point. For example, the outing plan generation unit 104 generates an outing plan for arriving at the transfer point slightly before the departure time of the public transportation. In this case, a waiting time at a station or a bus stop or a time loss in transfer can be minimized.

The outing plan generation unit 104 generates, for example, an outing plan proposed to each of a plurality of users. In generating an outing plan, the outing plan generation unit 104 generates an outing plan for each user so that the number of passengers in the carpool vehicle is equal to or less than a predetermined number. Here, the “predetermined number of passengers” is defined as the number of passengers less than the riding capacity of the vehicle and equal to or less than the number of passengers allowed in the vehicle excluding the driver. The predetermined number of passengers may change according to the relationship between the users sharing the same vehicle. For example, the predetermined number of passengers in a case where each user belongs to the same group such as a family may be greater than the predetermined number of passengers in a case where the users belong to different groups. By keeping the number of passengers in the carpool vehicle to a predetermined number or less, crowding of users in the vehicle can be avoided.

In the present example embodiment, the outing plan generation unit 104 refers to the congestion trend and generates an outing plan for each user so that the degree of congestion at the destination is equal to or less than a predetermined standard. For example, in a case where the congestion index in the morning is high at a facility as the destination, the outing plan generation unit 104 generates an outing plan for the user to use the facility in the afternoon. When the user transfers to public transportation, the outing plan generation unit 104 generates an outing plan for avoiding a train or a bus having a high congestion index and using a train or a bus having a low congestion index. The outing plan generation unit 104 corresponds to the outing plan generation means 13 illustrated in FIG. 1.

Note that the example in which the outing plan generation unit 104 generates an outing plan using the operation information of the carpool vehicle has been described above, but the present example embodiment is not limited thereto. For example, the vehicle operation information acquisition unit 103 may omit acquiring the operation information in a case where the carpool vehicle used by the user is a vehicle, such as a shared-ride taxi, whose travel route and operation time are determined according to the reservation status. In that case, the outing plan generation unit 104 may generate an outing plan using the carpool vehicle as transportation on the basis of the outing trend of the user acquired by the outing trend acquisition unit 101 and the congestion trend acquired by the congestion trend acquisition unit 102.

The outing plan transmission unit (outing plan transmission means) 105 transmits the outing plan generated by the outing plan generation unit 104 to a user terminal (terminal apparatus) 200 possessed by the user. The user terminal 200 can be configured as, for example, an apparatus such as a personal computer (PC), tablet, smartphone, or mobile phone. The outing plan transmission unit 105 transmits the outing plan to the user terminal 200 using, for example, an e-mail. Alternatively, the outing plan transmission unit 105 may transmit a uniform resource locator (URL) for referring to the outing plan to the user terminal 200. Each user can view the outing plan generated by the outing plan generation apparatus 100 using the user terminal 200. The user can reserve and use the carpool vehicle with reference to the outing plan proposed by the outing plan generation apparatus 100. Alternatively, the outing plan transmission unit 105 may transmit the outing plan to the user terminal 200 by voice through a telephone line.

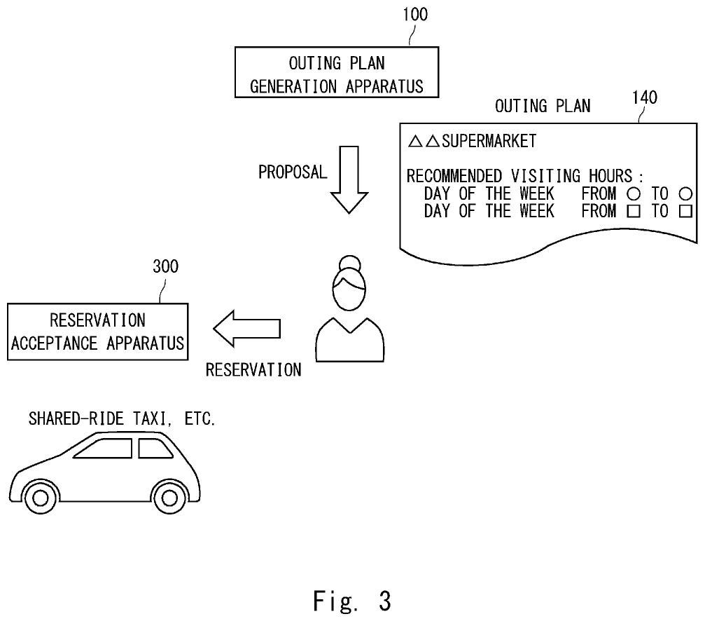

FIG. 3 schematically illustrates reservation of a carpool vehicle. For example, the user connects to the outing plan generation apparatus 100 using the user terminal 200 and inputs a personal ID (identifier) for identifying the user. The user connects to the outing plan generation apparatus 100 by, for example, accessing a predetermined web page, for example, and inputs the personal ID. Alternatively, the user may connect to the outing plan generation apparatus 100 by calling a designated phone number and input the personal ID. The user designates to the outing plan generation apparatus 100 the date or week for which the user wants to know the details of the proposed outing plan. The user can designate a date or week up to two weeks in advance to the outing plan generation apparatus 100. The user can also select a time unit, such as a day or a week, for which the user desires to generate an outing plan. The outing plan generation apparatus 100 generates an outing plan in the designated period. The outing plan generation apparatus 100 transmits the generated outing plan to the user terminal 200. The outing plan generation apparatus 100 may provide the outing plan to the user by voice through a telephone line.

The user refers to the outing plan 140 proposed by the outing plan generation apparatus 100. The outing plan 140 includes, for example, information on the name of the destination supermarket store, and the set of days and time zones to go out. The outing plan 140 may include, for example, a plurality of sets of days and time zones. The user can determine the date and time zone to go to the supermarket with reference to the outing plan 140. In a case where the date and the time zone are determined, the user makes a reservation for using the carpool vehicle to the reservation acceptance apparatus 300. The reservation acceptance apparatus 300 is disposed in, for example, a company that operates carpool vehicles. Note that the outing plan generation apparatus 100 and reservation acceptance apparatus 300 are not necessarily configured as separate apparatuses. The outing plan generation apparatus 100 may include the function of the reservation acceptance apparatus 300.

For example, the reservation acceptance apparatus 300 provides a web page that accepts a reservation for a carpool vehicle. The user accesses a web page using a PC, smartphone, or the like, and inputs information such as the date and time the user will use the carpool vehicle into the reservation acceptance apparatus 300. The user has only to reserve the carpool vehicle with reference to the outing plan 140, and does not necessarily need to reserve a carpool vehicle according to the outing plan 140. In a case where the user reserves a carpool vehicle at the date and time proposed in the outing plan 140, the user may input an outing plan ID for identifying the outing plan to the reservation acceptance apparatus 300. The reservation acceptance apparatus 300 may accept a reservation by voice through a telephone line.

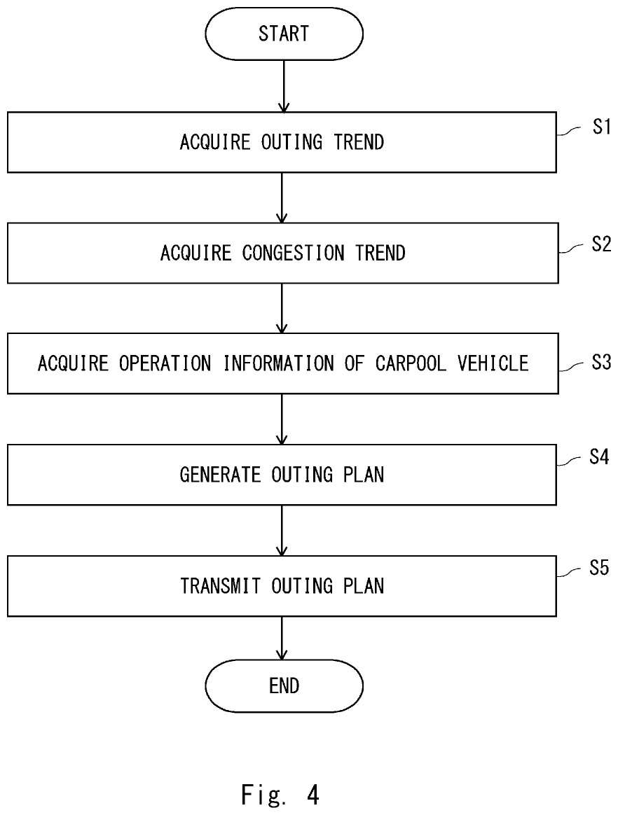

Next, an operation procedure will be described. FIG. 4 illustrates an operation procedure (outing plan generation method) in the outing plan generation apparatus 100. The outing trend acquisition unit 101 acquires the outing trend of the user (step S1). The congestion trend acquisition unit 102 acquires the congestion trend of the public facility at the destination (step S2). The vehicle operation information acquisition unit 103 acquires operation information of the carpool vehicle (step S3).

The outing plan generation unit 104 generates an outing plan on the basis of the outing trend, congestion trend, and operation information of the carpool vehicle (step S4). In step S4, the outing plan generation unit 104 may generate a usage plan for each of a plurality of users. In step S4, the outing plan generation unit 104 generates an outing plan so as to avoid congestion in the public facility at the outing destination. In a case where an outing plan has been generated for the user in the past, the outing plan generation unit 104 may generate an outing plan taking into account whether the user went out according to the outing plan or not.

The outing plan transmission unit 105 transmits the outing plan generated in step S4 to the user terminal 200 (step S5) and proposes the outing plan to the user. The user can reserve a carpool vehicle with reference to the outing plan 140 (see FIG. 3). In a case where the user uses a carpool vehicle, information such as the personal ID, riding time, and the destination of the user is stored as the usage record information in a usage record database (not illustrated). In a case where the user uses a carpool vehicle according to the outing plan 140, the personal ID and outing plan ID of the user may be stored as the usage record information in a usage record database.

In the present example embodiment, the outing plan generation unit 104 generates an outing plan on the basis of the outing trend and operation information of the carpool vehicle as well as the congestion trend at the destination. The outing plan generation apparatus 100 transmits the generated outing plan to the user terminal 200, and proposes the outing plan to the user. The user can go out using the carpool vehicle in a time zone when the destination is not congested with reference to the outing plan. Therefore, the outing plan generation apparatus 100 can allow the user to use the public facility or the like at the outing destination while avoiding congested times.

In the present example embodiment, by using a carpool vehicle, the user can travel relatively freely without having a private car. Therefore, the present example embodiment can increase the opportunity to go out for those who do not have a driver's license, such as elderly persons. Furthermore, in the present example embodiment, the outing plan generation apparatus 100 can generate an outing plan that keeps the number of passengers in a carpool vehicle to a predetermined number or less. In this case, congestion in the carpool vehicle as transportation can be reduced. In addition, the outing plan generation apparatus 100 can reduce congestion at each facility, where the user goes out, through the outing plan proposed to the user. A commercial facility such as a supermarket, where the user goes out, may take a measure such as holding a sale in a time zone when the number of visitors is relatively small. In this case, the use of the service of the outing plan generation apparatus 100 can be promoted and store sales can be increased.

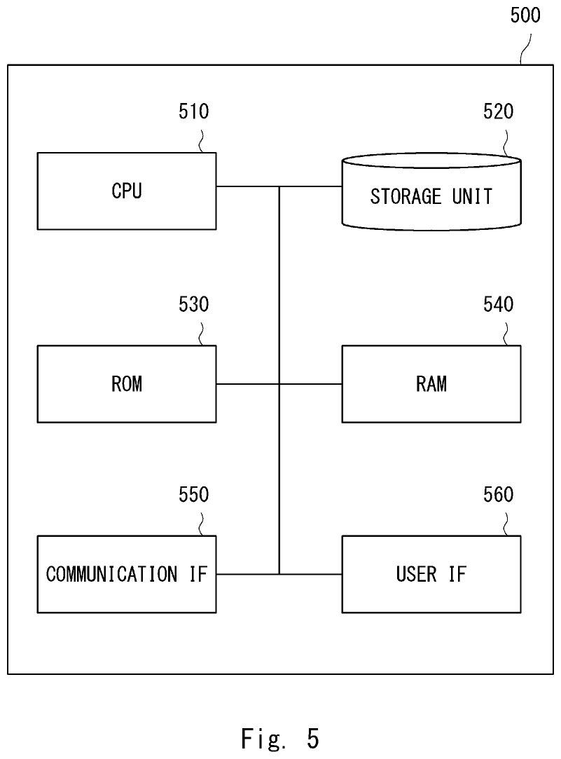

Next, a physical configuration of the outing plan generation apparatus 100 will be described. In the present disclosure, the outing plan generation apparatus 100 can be configured as a computer apparatus (a server apparatus). FIG. 5 illustrates an example of a configuration of a computer apparatus that can be used as the outing plan generation apparatus 100. A computer apparatus 500 includes a control unit (a central processing unit (CPU)) 510, a storage unit 520, a read only memory (ROM) 530, a random access memory (RAM) 540, a communication interface (IF) 550, and a user interface 560.

The communication interface 550 is an interface for connecting the computer apparatus 500 to a communication network through wired communication means, wireless communication means, or the like. The user interface 560 includes, for example, a display unit such as a display. The user interface 560 also includes input units such as a keyboard, a mouse, and a touch panel.

The storage unit 520 is an auxiliary storage device that can hold various types of data. The storage unit 520 does not necessarily have to be a part of the computer apparatus 500, but may be an external storage device, or a cloud storage connected to the computer apparatus 500 via a network.

The ROM 530 is a non-volatile storage device. For example, a semiconductor storage device such as a flash memory having a relatively small capacity can be used for the ROM 530. Programs that are executed by the CPU 510 can be stored in the storage unit 520 or ROM 530. The storage unit 520 or ROM 530 stores, for example, various programs for realizing the function of each unit in the outing plan generation apparatus 100.

The aforementioned programs can be stored and supplied to the computer apparatus 500 using various types of non-transitory computer readable media. Non-transitory computer readable media include various types of tangible storage media. Examples of non-transitory computer readable media include magnetic storage media such as floppy disks, magnetic tapes, and hard disk drives, optical magnetic storage media such as magneto-optical disks, optical disk media such as CD (Compact Disc) and DVD (Digital Versatile Disk), and semiconductor memories such as mask ROM, PROM (Programmable ROM), EPROM (Erasable PROM), flash ROM, and RAM. Further, the programs may be provided to computers using various types of transitory computer readable media. Examples of the transitory computer readable media include electric signals, optical signals, and electromagnetic waves. Transitory computer readable media can provide the program to a computer via a wired communication line such as electric wires and optical fibers or a radio communication line.

The RAM 540 is a volatile storage device. As the RAM 540, various types of semiconductor memory apparatuses such as a DRAM (Dynamic Random Access Memory) or an SRAM (Static Random Access Memory) can be used. The RAM 540 can be used as an internal buffer for temporarily storing data and the like. The CPU 510 expands a program stored in the storage unit 520 or the ROM 530 in the RAM 540, and executes the expanded program. The function of each unit in the outing plan generation apparatus 100 can be realized by the CPU 510 executing the programs. The CPU 510 may include an internal buffer in which data and the like can be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

The whole or part of the example embodiments disclosed above can be described as, but not limited to, the following supplementary notes.

### [Supplementary Note 1]

An outing plan generation apparatus including:
an outing trend acquisition means for acquiring an outing trend including a trend of departure place, destination, and time zone in an outing of a user;
a congestion trend acquisition means for acquiring a congestion trend at the destination of the user; and
an outing plan generation means for generating an outing plan that uses the carpool vehicle as transportation on the basis of the outing trend of the user and the congestion trend.

### [Supplementary Note 2]

The touting plan generation apparatus according to Supplementary note 1, further including an operation information acquisition means for acquiring operation information including a travel route and an operation time of the carpool vehicle,
in which the outing plan generation means further generates the outing plan on the basis of the operation information.

### [Supplementary Note 3]

The outing plan generation apparatus according to Supplementary note 1 or 2, in which the outing plan generation means generates an outing plan in which the degree of congestion at the destination is equal to or less than a predetermined standard.

### [Supplementary Note 4]

The outing plan generation apparatus according to any one of Supplementary notes 1 to 3, in which the outing plan generation means generates an outing plan in which the number of passengers in the carpool vehicle is equal to or less than a predetermined number.

### [Supplementary Note 5]

The outing plan generation apparatus according to any one of Supplementary notes 1 to 4, in which the outing trend acquisition means acquires an outing trend according to a user characteristic of the user.

### [Supplementary Note 6]

The outing plan generation apparatus according to Supplementary note 5, in which the user characteristic includes at least one of age, gender, and residential area of the user.

### [Supplementary Note 7]

The outing plan generation apparatus according to Supplementary note 5 or 6, in which the user characteristic includes a past usage record of the carpool vehicle.

### [Supplementary Note 8]

The outing plan generation apparatus according to any one of Supplementary notes 1 to 7, in which
the destination is a transfer point to public transportation, and
the congestion trend acquisition means acquires a congestion trend of public transportation to be transferred at the transfer point as congestion trend of the destination.

### [Supplementary Note 9]

The outing plan generation apparatus according to Supplementary note 8, in which the outing plan generation means generates the outing plan in accordance with a departure time of public transportation at the transfer point.

### [Supplementary Note 10]

The outing plan generation apparatus according to any one of Supplementary notes 1 to 9, further including an outing plan transmission means for transmitting the outing plan to a terminal apparatus possessed by the user.

### [Supplementary Note 11]

An outing plan generation method including:
acquiring an outing trend including a trend of departure place, destination, and time zone in an outing of a user;
acquiring a congestion trend at the destination of the user; and
generating an outing plan that uses the carpool vehicle as transportation on the basis of the outing trend of the user and the congestion trend.

### [Supplementary Note 12]

A non-transitory computer readable medium storing a program to cause a computer to execute:
acquiring an outing trend including a trend of departure place, destination, and time zone in an outing of a user;
acquiring a congestion trend at the destination of the user; and
generating an outing plan that uses the carpool vehicle as transportation on the basis of the outing trend of the user and the congestion trend.

### REFERENCE SIGNS LIST

10 OUTING PLAN GENERATION APPARATUS
11 OUTING TREND ACQUISITION MEANS
12 CONGESTION TREND ACQUISITION MEANS
13 OUTING PLAN GENERATION MEANS
100 OUTING PLAN GENERATION APPARATUS
101 OUTING TREND ACQUISITION UNIT
102 CONGESTION TREND ACQUISITION UNIT
103 VEHICLE OPERATION INFORMATION ACQUISITION UNIT
104 OUTING PLAN GENERATION UNIT
105 OUTING PLAN TRANSMISSION UNIT
200 USER TERMINAL
140 OUTING PLAN
300 RESERVATION ACCEPTANCE APPARATUS

What is claimed is:

1. An outing plan generation apparatus comprising:
a memory storing instructions; and
a processor configured to execute the instructions to:
acquire an outing trend including a trend of a departure place, a destination, and a time zone in an outing of a user;
acquire a congestion trend at the destination of the user; and
generate an outing plan that uses a carpool vehicle as transportation on a basis of the outing trend of the user and the congestion trend.

2. The outing plan generation apparatus according to claim 1, wherein the processor is configured to execute the instructions to:
acquire operation information including a travel route and an operation time of the carpool vehicle, and
generate the outing plan on a basis of the operation information.

3. The outing plan generation apparatus according to claim 2, wherein the processor is configured to execute the instructions to generate an outing plan in which a degree of congestion at the destination is equal to or less than a predetermined standard.

4. The outing plan generation apparatus according to claim 1, wherein the processor is configured to execute the instructions to generate an outing plan in which a number of passengers in the carpool vehicle is equal to or less than a predetermined number.

5. The outing plan generation apparatus according to claim 1, wherein the processor is configured to execute the instructions to acquire an outing trend according to a user characteristic of the user.

6. The outing plan generation apparatus according to claim 5, wherein the user characteristic includes at least one of age, gender, and residential area of the user.

7. The outing plan generation apparatus according to claim 5, wherein the user characteristic includes a past usage record of the carpool vehicle.

8. The outing plan generation apparatus according to claim 1, wherein
the destination is a transfer point to public transportation, and
the processor is configured to execute the instructions to acquire a congestion trend of public transportation to be transferred at the transfer point as congestion trend of the destination.

9. The outing plan generation apparatus according to claim 8, wherein the processor is configured to execute the instructions to generate the outing plan in accordance with a departure time of public transportation to be transferred at the transfer point.

10. The outing plan generation apparatus according to claim 1, the processor is further configured to execute the instructions to transmit the outing plan to a terminal apparatus possessed by the user.

11. An outing plan generation method comprising:
acquiring an outing trend including a trend of departure place, destination, and time zone in an outing of a user;
acquiring a congestion trend at the destination of the user; and
generating an outing plan that uses a carpool vehicle as transportation on a basis of the outing trend of the user and the congestion trend.

12. A non-transitory computer readable medium storing a program to cause a computer to execute:
acquiring an outing trend including a trend of departure place, destination, and time zone in an outing of a user;
acquiring a congestion trend at the destination of the user; and
generating an outing plan that uses a carpool vehicle as transportation on a basis of the outing trend of the user and the congestion trend.
